(19) United States
(12) Patent Application Publication
(10) Pub. No.: US 2013/0197678 A1
(43) Pub. Date: Aug. 1, 2013

(54) INFORMATION PROCESSING SYSTEM, SERVER, AND INFORMATION PROCESSING METHOD

(71) Applicants: Koji Ara, Higashiyamato (JP); Kazuo Yano, Hino (JP); Nobuo Sato, Saitama (JP); Satomi Tsuji, Koganei (JP); Tomoaki Akitomi, Tokyo (JP)

(72) Inventors: Koji Ara, Higashiyamato (JP); Kazuo Yano, Hino (JP); Nobuo Sato, Saitama (JP); Satomi Tsuji, Koganei (JP); Tomoaki Akitomi, Tokyo (JP)

(73) Assignee: Hitachi, Ltd.

(21) Appl. No.: 13/698,437

(22) PCT Filed: May 16, 2011
(86) PCT No.: PCT/JP2011/002689

§ 371 Date: Jan. 25, 2013

(30) Foreign Application Priority Data
May 21, 2010 (JP) 2010-116895

(51) Int. Cl. G05B 19/02

(52) U.S. Cl. CPC G05B 19/02
USPC 700/83

(57) ABSTRACT

The present disclosures identify of which group the environmental conditions have problems and waste, and enable effective energy management in locations such as schools and businesses where a plurality of people are in a plurality of spaces such as rooms, floors, and buildings. Terminals each worn by a plurality of users who constitute an organization acquire using sensors—and transit to a server—environmental information such as temperature, humidity, and illumination. The server tabulates the environmental information, calculates the environmental information of each group that the plural users constitute, and presents the environmental information along with the name and responsible party of the group.

### TECHNICAL FIELD

The present invention relates to a technique that collects, aggregates, and displays environment information such as temperature, humidity, and illuminance using sensor devices.

### BACKGROUND ART

A scheme of measuring and analyzing energy in a space such as a building where a plurality of people live and work is called a BEMS (Building Energy Management System) (a registered trademark) and put into practical use. An absolute value of energy usage, power consumptions for different systems such as for air conditioners and for lighting fixtures, the effects of energy saving systems are output in real time. A technique for controlling air conditioners using this BEMS method is known (refer to, e.g., Patent Literature 1).

Techniques are under study that acquire environment information such as temperature and illuminance using sensing devices and utilize such information for energy saving, i.e., making efficient use of electricity, water, etc. For instance, in Patent Literature 2, a mobile phone is equipped with various sensors such as a temperature sensor, odor sensor, humidity sensor, infrared sensor, and acceleration sensor. Based on their detection outputs, circumstances of the mobile phone are judged comprehensively and operation control is performed according to the judged conditions. For example, if a temperature above or below a predetermined temperature has been detected by a temperature sensor, a voice message asking whether to power on an air conditioner is output and controlled, a control command to control the power-on is transmitted by near field radio communication, and the air conditioner is remotely operated.

An approach in which a person always wears a sensing device is underway and a study for constant measurement of a pulse and temperature with an armlet form of sensor is pursued (refer to, e.g., Nonpatent Literature 1). Study efforts to use a name plate form of sensor and measure an amount of face-to-face communication between persons and an amount of speech by infrared light are also pursued (refer to, e.g., Nonpatent Literature 2). Moreover, a study that attempts to analyze a relation between a communication pattern and productivity in an organization has begun (refer to, e.g., Nonpatent Literature 3).

### CITATION LIST

### Patent Literature

Patent Literature 1: Japanese Unexamined Patent Application Publication No. 2008-298296
Patent Literature 2: Japanese Unexamined Patent Application Publication No. 2007-135008

### Nonpatent Literature

Nonpatent Literature 1: Tanaka, “Life Microscope: Continuous daily-activity recording system with tiny wireless sensor”, International Conference on Networked Sensing Systems, Jun. 17, 2008, pp. 162-165
Nonpatent Literature 2: Wakisaka, “Beam-Scan Sensor Node: Reliable Sensing of Human Interactions in Organization”, International Conference on Networked Sensing Systems (U.S.), Jun. 17, 2009
Nonpatent Literature 3: Lynn, “Mining Face-to-Face Interaction Networks Using Sociometric Badges: Evidence Predicting Productivity in IT Configuration”, International Conference on Information Systems, (France), Dec. 14, 2008

### SUMMARY OF INVENTION

### Technical Problem

Patent Literature 1 relates to energy management. By using the energy monitoring system, it is possible to grasp which room has a large amount of consumption, which floor has a large amount of consumption, etc. and it is possible to grasp energy consumption and environment information per room and building, if output systems are respectively associated with the floors and rooms of a building. In measuring energy, thermometers, hygrometers, etc. are used.

In contrast, the present inventors are carrying on a study that collects environment information by directly sensing monitored persons belonging to an organization and conducts energy management of the organization. Through this, we noticed that some constraint of an organization that manages an activity space of monitored persons of the organization has a large effect on energy management.

Generally, energy management is conducted by performing energy measurements and analysis on a per-place basis. Stationary sensors such as thermometers and hygrometers used in Patent Literature 1 are also often disposed on a per-place basis. If an organization manager grasps energy consumption and environment information and instructs an employee to change the setting of equipment such as air conditioners to suppress energy consumption, an organizational constraint will not come into the open. On the other hand, energy management that is conducted based on environment information collected by directly sensing monitored persons belonging to an organization depends on which place where each monitored person is operating in the organization. In this case, situations in which conducting energy management on a per-place basis is not suitable may arise occasionally.

Concretely, an example hereof is a situation where a plurality of organizations exist in a same space. It is a case where, for example, a group A and a group B exist in a room 1. The leaders of the groups are assumed to be a leader a and a leader b. Although someone can give a command to all employees in the groups A and B, it is generally the leader of each group who is able to give instructions to each employee. Then, suppose that the leader a instructed an employee to decrease the setting of an air conditioner for use, giving care to environment. However, suppose that the other leader b does not give care to environment. If energy charge payment is evenly shared by both groups, persons in the group B may think that it is no matter if our group uses somewhat more energy and increase the setting of the air conditioner. In consequence, the group A may feel that our group only makes an effort for energy saving, but it leads to nothing.

Although this is one example, efficient energy management may be impeded by some organizational constraint, if energy management is conducted on a per-place basis in a case that a plurality of organizations exist in a same space, because of the same place. Thus, if a plurality of organizations exist in a same space, it is important for an organization manager to grasp circumstances per group and give instructions or a command.

Another example is that one organization is separately located in a plurality places or that a group works in a place different from its routine workplace. For example, it may happen naturally that a group C that routinely works in a room 2 works in a room 3 of another group D. Employees of the group C may not be motivated to reduce energy consumption in the room 3, because they are not responsible for energy management of this room. So, they may increase the setting of the air conditioner in the room and waste energy. An organization manager who conducts energy monitoring on a per-room basis may instruct a person in the group D that uses this space routinely to reduce energy consumption, but this cannot lead to efficient energy management.

In Patent Literature 2, a mobile phone is equipped with various sensors and energy management is conducted. However, this is intended for a place where one person is present in one space, but no consideration is taken for a situation where a plurality of persons are present in a plurality of spaces.

To summarize the foregoing, considering places such as schools and companies where a plurality of persons are present in a plurality of spaces such as rooms, floors, and buildings, it is necessary to identify a problem properly and give instructions on behavior in a case where a plurality of organizations exist in one place and a case where one organization exists in a plurality of places including its routine workplace.

### Solution to Problem

Typical aspects of the invention disclosed herein in the present application will be summarized below.

An aspect is an information processing system including a terminal that is attached to each of a plurality of users who constitute an organization, a base station that communicates with the terminal, and a server connected to the base station via a network. The terminal includes a first sensor acquiring environment information and a transmitter that transmits the environment information to the base station. The server includes a network interface connected to the network, a processor connected to the network interface, and a recording device connected to the processor. The recording device records a personal information table that stores an association of each of the plurality of users with a person group to which each of the plurality of users belongs in the organization. The processor receives the environment information via the network interface and records the environment information into the recording device; based on the environment information, aggregates and records environment information for each user for a given period into the recording device; and refers to the personal information table, calculates environment information for each person group for a given period from the environment information for each user for a given period, and outputs the result to a display device connected to the information processing system.

Also, an aspect is a server connected via a network to a base station communicating with a terminal that is attached to each of a plurality of users who constitute an organization. The server includes a network interface connected to the network, a processor connected to the network interface, and a recording device connected to the processor. The recording device records a personal information table that stores an association of each of the plurality of users with a person group to which each of the plurality of users belongs in the organization. The processor receives environment information acquired by the terminal via the network interface and stores the environment information into the recording device; based on the environment information, aggregates and records environment information for each user for a given period into the recording device; and refers to the personal information table, calculates environment information for each person group for a given period from the environment information for each user for a given period, and outputs the result to a display device connected to the network.

An aspect is an information processing method using an information processing system including a terminal that is attached to each of a plurality of users who constitute an organization, a base station that communicates with the terminal, and a server connected to the base station via a network. The terminal acquires environment information and transmits the environment information to the base station. The server associates beforehand each of the plurality of users to a person group to which each of the plurality of users belongs in the organization; based on the environment information, the server aggregates environment information for each user for a given period; using an association of each of the plurality of users with each person group, the server calculates environment information for each person group for a given period from the environment information for each user for a given period. Further, the environment information for each person group for a given period is displayed.

### Advantageous Effects of Invention

According to the present invention, even if a plurality of organizations operate across a plurality of places, it is clarified that environmental conditions of which person group are problematic and wasteful and efficient energy management can be conducted.

### BRIEF DESCRIPTION OF DRAWINGS

FIG. 1 shows an example of an overall system structure according to a first embodiment.

FIG. 2 shows examples of table structures storing sensed data according to the first embodiment.

FIG. 3 shows an example of a personal information table according to the first embodiment.

FIG. 4 shows an example of an organization configuration according to the first embodiment.

FIG. 5 shows an example of a behavior analysis data table according to the first embodiment.

FIG. 6 shows an example of a flow of calculating activity of a worker according to the first embodiment.

FIG. 7 shows an example of a position locating device list according to the first embodiment.

FIG. 8 shows an example of a behavior analysis aggregation data table according to the first embodiment.

FIG. 9 shows an example of a group-wise behavior analysis aggregation data table according to the first embodiment.

FIG. 10 shows an example of a place-wise aggregation data table according to the first embodiment.

FIG. 11 shows an example of a work efficiency data table according to the first embodiment.

FIG. 12 shows an example of a screen displaying temperature distributions and proper temperature according to the first embodiment.

FIG. 13 shows an example of a screen displaying temperature distributions per floor according to the first embodiment.

FIG. 14 shows an example of a screen displaying temperature distributions per room according to the first embodiment.

FIG. 15 shows an example of a screen displaying a relation between activeness rates of face-to-face interaction and temperature according to the first embodiment.

FIG. 16 shows an example of a screen displaying temperature change over time together with proper temperature according to the first embodiment.

FIG. 17 shows an example of a screen for analyzing a relation between behavior and temperature according to the first embodiment.

FIG. 18 show an example of an overall system structure according to a second embodiment.

FIG. 19 shows an example of a screen for analyzing a relation between behavior and cooling water consumption according to the second embodiment.

### DESCRIPTION OF EMBODIMENTS

In the following, embodiments of the present invention will be described in detail with reference to the drawings. Components marked with identical signs represent identical or similar constituents.

### First Embodiment

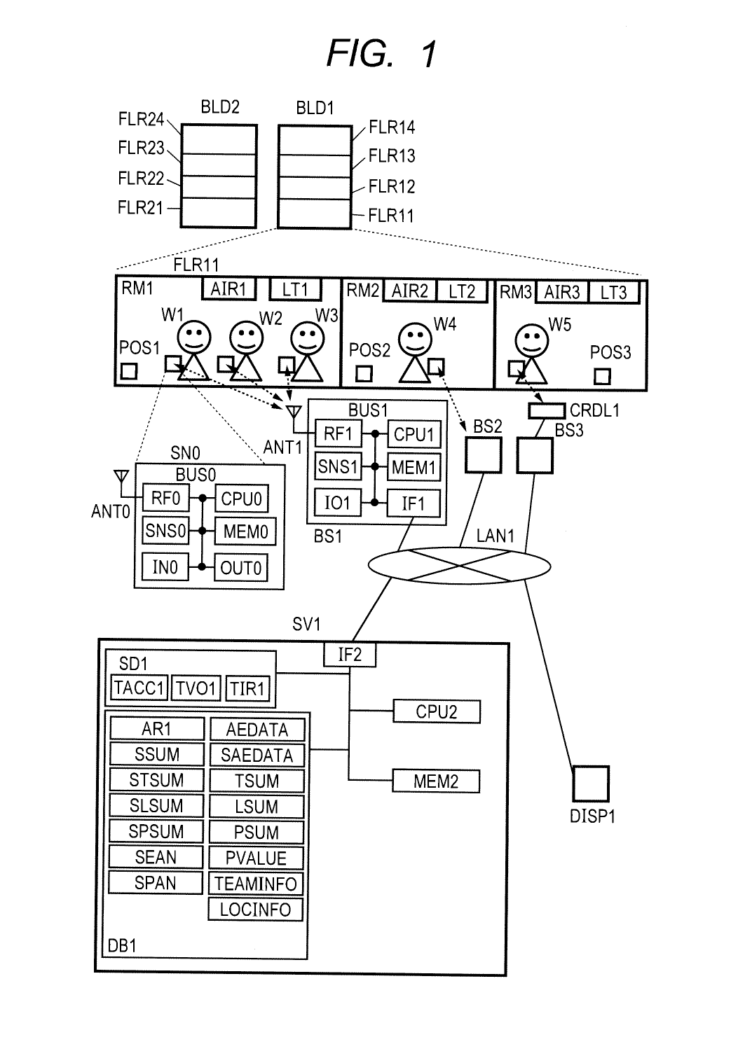

FIG. 1 shows a system structure according to a first embodiment of the present invention. An embodiment is described for a case where one company occupies two buildings BLD1 and BLD2. Each building is a four-story one; for example, BLD1 is made up of floors FLR11 to FLR14 and BLD2 is made up of floors FLR21 to FLR24. An internal structure of a floor is described, taking FLR11 as an example. This floor is divided into three rooms RM1 to RM3. In each room, air conditioners AIR1 to AIR3 and lighting fixtures LT1 to LT3 are installed.

Workers W1 to W5 carry a sensor node SN0 equipped with various sensors. They may carry a plurality of sensor nodes. The sensor node SN0 is comprised of a processor CPU0, a radio circuit RF0 provided with an antenna ANT0, a suite of sensors SNS0 such as sound, acceleration, temperature, humidity, illuminance, infrared, color, and human motion sensors and RFID, a memory MEM0 storing a sensing program, an input device IN0 such as buttons, and an output device OUT0 such as LCD, LED, and a buzzer.

The sensor node acquires sensed data from various sensors in a given sampling period (such as, e.g., 0.05 seconds) by execution of the sensing program by the processor CPU. Then, the sensor node appends an identifier identifying the sensor node and a time stamp or the like to the acquired sensed data and transmits the data to a base station device.

The sensor node can be realized in various shapes. If the node is made in a shape like an armlet, which is directly attached to a body, it is known that a pulse rate can be sensed by emitting infrared light toward inside the body and sensing its reflection. This takes advantage of a property of blood that absorbs infrared light and, thus, a change in a blood flow can be inferred from reflection. If the node is made in a shape like a sensor node of a name tag form, which is attached outward to a garment, it is known that a face-to-face interaction between persons wearing such name tag nodes can be detected by providing the node with a function of emitting infrared light outward and a function of receiving infrared light incoming from outside. That is, when a worker W1 and another worker W2, both wearing sensor nodes SN0 of a name tag form, face to face interact with each other, their mutual identifiers are transmitted and received by infrared communication. Details of control of sensor nodes can be implemented in the same way as in Nonpatent Literature 1 and Nonpatent Literature 2.

Information sensed by a sensor node SN0 is transmitted to a base station device BS1 directly by radio communication or via a relay device. Alternatively, sensed information may be collected by a cradle CRDL1 having a function as a charger for data collection via wired communication and transferred to the base station BS1. Information received by the base station BS1 is stored into a sensor database SD1 at a management server SV1 via a wired network LAN11.

The base station device BS1 is comprised of a processor CPU1, a radio circuit RF1, a suite of sensors SNS1 such as sound, acceleration, temperature, humidity, illuminance, infrared, color, and human motion sensors and RFID, a memory MEM1 storing a data transmission/reception program and a sensor node management program, an input/output device IO0 such as buttons, LCD, LED, a buzzer, and a display, and an input/output interface IF1 interfacing with an external network such as Internet.

By execution of the data transmission/reception program by the processor CPU1, the base station BS1 receives sensed data from a sensor node via radio or wire and transmits the data to which it appends its identifier to the management server SV1 via the wired network LAN1.

Position locating devices POS1 to POS3 are hardware that is installed for the purpose of detecting that a worker is present in the space. For example, a position locating device transmits infrared light including its identifier at given intervals and, when a worker W1 wearing a sensor node SN0 of a name plate form works in front of it, it can detect the worker W1 with the aid of the sensor node SN0. The position locating device transmits this detection information by radio communication, the management server SV1 can know a working place of each worker by association of received identifiers with information for the installation site of the position locating device. Other than using the infrared light, it is possible to narrow down an area where a worker is present by data transmission/reception and positioning technology or to locate a place using an RFID reader.

A display device DISP1 that is used by a data viewer is connected to LAN1 via wire or a wireless LAN.

The management server SV1 includes a network interface IF2, a processor CPU2, a memory MEM2, a sensor database SD1, and a recording device DB1. The network interface IF2 is an interface for connecting to the wired network LAN1. The sensor database SD1 is to store sensed data acquired by various sensors. The recording device DB1 is to record various programs and various data tables which will be described later. The sensor database SD1 and the recording device DB1 are, for example, a hard disk drive, CD-ROM drive, flash memory, etc. The sensor database SD1 and the recording device DB1 can also be constructed with a single recording device.

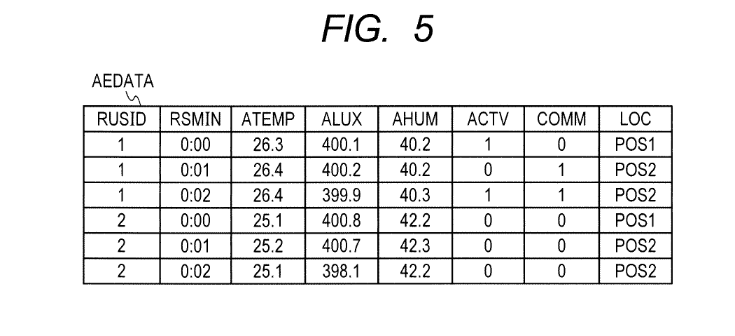

The processor CPU2 implements various functions by reading various programs stored in the recording device DB to the memory MEM2 and executing them. Concretely, by executing a behavior analysis program AR1, the processor CPU2 aggregates sensed data and analyzes behavior information and environment information of each worker from aggregated values per unit time (e.g. one minute). Here, behavior information indicates whether each worker is in an active state and whether the worker face to face interacts with another worker. Environment information is temperature, illuminance, humidity, etc. Behavior analysis data resulting from the analysis is stored into a behavior analysis data table AEDATA which is shown in FIG. 5.

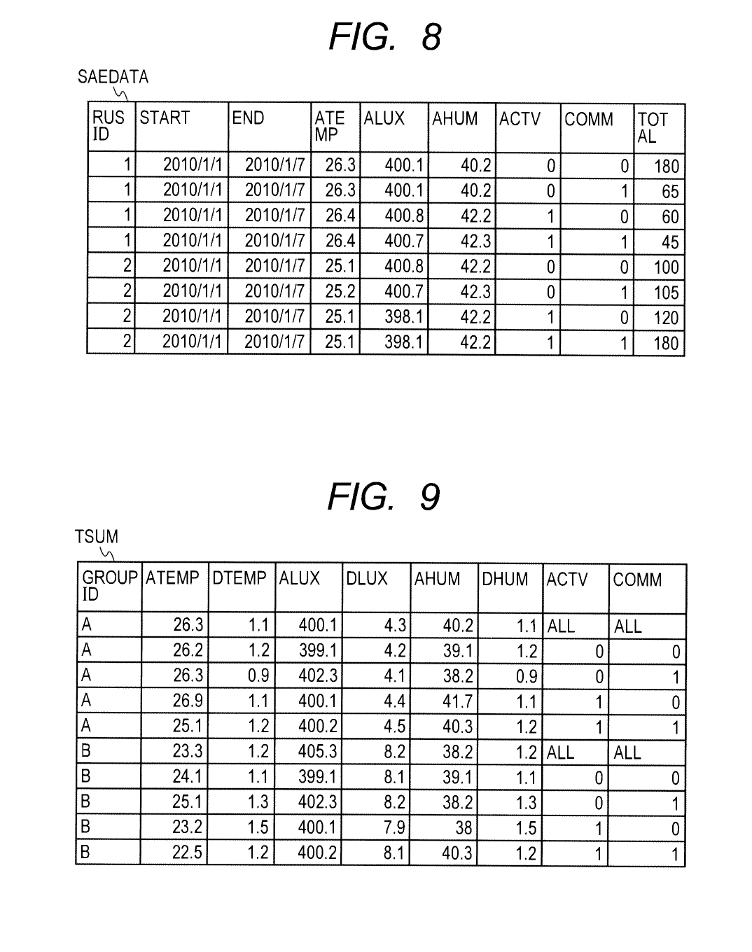

Also, by executing a state aggregation program SSUM, the processor CPU2 aggregates environment information such as temperature when each worker was working separately according to behavior types, based on behavior analysis data. Behavior analysis aggregation data resulting from the aggregation is stored into a behavior analysis aggregation data table SAEDATA which is shown in FIG. 8. Moreover, by executing a group-wise aggregation program STSUM, the processor CPU2 aggregates environment information such as temperature during working for each group or team separately according to behavior types, based on behavior analysis data. Group-wise behavior analysis aggregation data resulting from the aggregation is stored into a group-wise behavior analysis aggregation data table TSUM which is shown in FIG. 9.

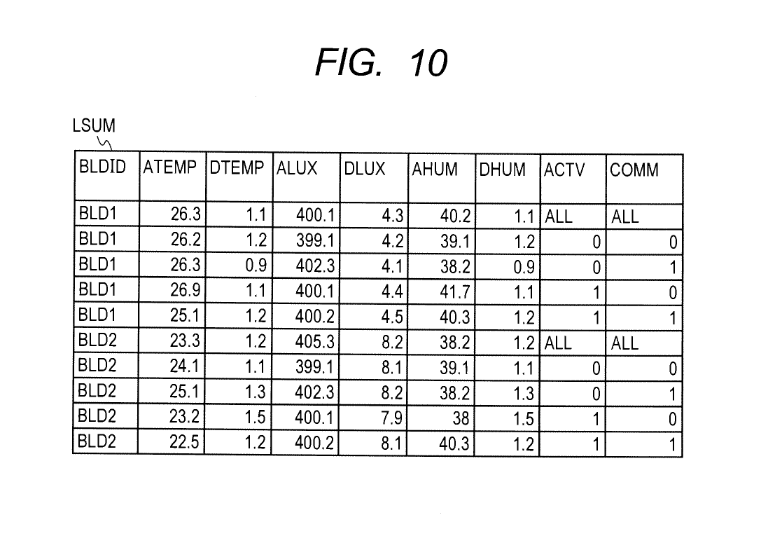

Also, by executing a place-wise aggregation program SLSUM, the processor CPU2 aggregates environment information such as temperature during working for each place separately according to behavior types, based on behavior analysis data. Place-wise aggregation data resulting from the aggregation is stored into a place-wise aggregation data table LSUM which is shown in FIG. 10.

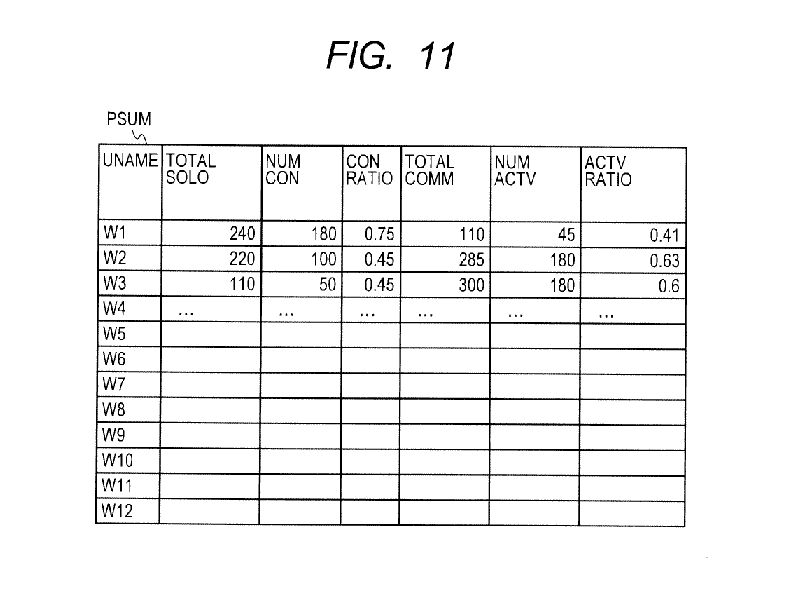

Also, by executing a behavior analysis program SPSUM, the processor CPU2 calculates work efficiency data indicating the work efficiency of each worker and stores this data into a work efficiency data table PSUM which is shown in FIG. 11. Further, by executing a proper environment analysis program SEAN, the processor CPU2 calculates proper environment information (e.g., proper temperature) PVALUE based on the work efficiency data and environment information of each worker.

Moreover, by executing a behavior and environment information correlation analysis program SPAN, the processor CPU2 analyzes a correlation between a behavior indicator and environment information for each worker.

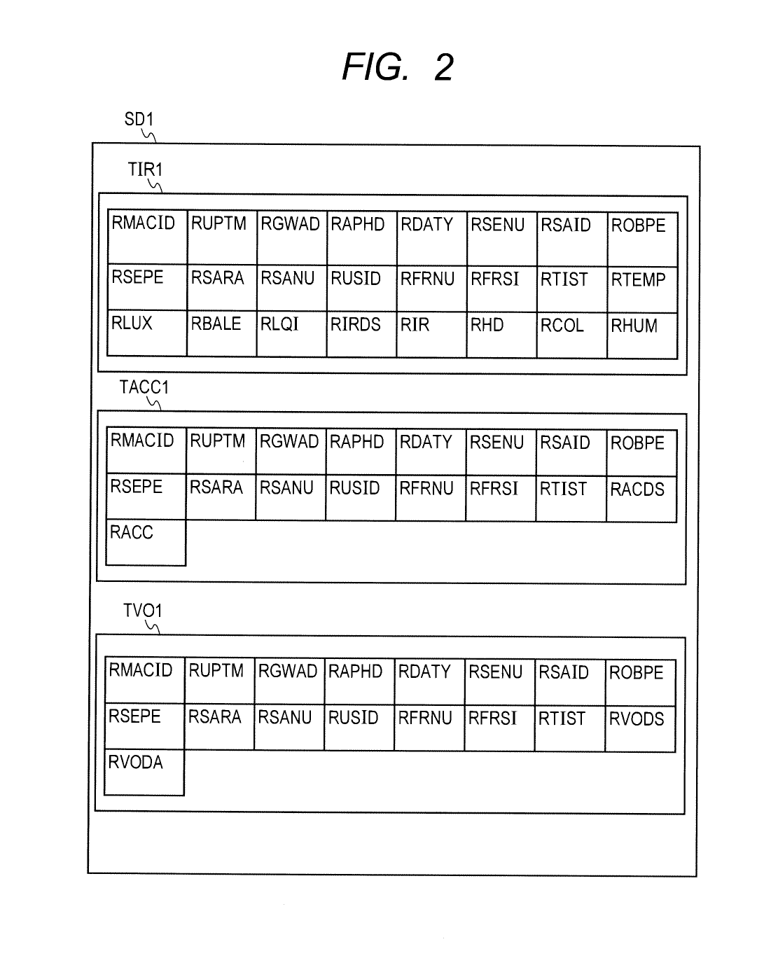

FIG. 2 is a diagram showing examples of sensed data that is stored in the sensor database SD1 of the management server SV1 upon receiving by the management server sensed data transmitted by a sensor node. In the sensor database SD1, sensed data, identification information of a sensor node that a worker utilizes, identification information of the worker, etc. are associatively managed.

A table TIR1 is a table that associatively stores temperature data, illuminance data, and infrared detection data. In a column RMACID, a device's network address is stored. In a column RUPTM, time at which data has been stored in the table SD1 is stored. In a column RGWAD, the identifier of a base station device (e.g., BS1) from which the data has been received via radio is stored. In a column RAPHD, a sensor node type is stored. For example, 1 for a sensor node of an armlet form, 2 for a sensor node of a name tag form, etc. are stored. In a column RDATY, a type of data stored in a radio packet is stored. For example, 1 for a set of temperature data, illuminance data, and infrared detection data as stored data, 2 for acceleration data, 3 for sound data, etc. are stored. A column RSENU is a periodic counter that gives 0000 to FFFF to frames in order of transmission by the sensor node and, following FFFF, resets it to 0000. In the case of a concatenation of split frames, a first frame's sequence number is stored. In a column RTHE, a same sampling identifier is given to slit frames containing data sampled in a same sampling period. Ina column ROBPE, the current sensing interval (e.g., 10 seconds/cycle) of the sensor node is stored. In a column RSEPE, the current radio transmission interval of the sensor node is stored. This interval may be either a value representing the interval or a value of a multiple of the sensing interval. In RSARA, a sensor data acquisition period (e.g., 50 Hz) at the sensor node is stored. In a column RSANU, the current number of times of sampling at the sensor node is stored. In a column RUSID, identification ID of a user who utilizes this node is stored. In a column RFRNU, if a frame of data transmitted by the sensor node is split into a plurality of subframes which are a total of n split frames, they are numbered in descending order such as n, n−1, n−2, . . . 3, 2, 1. It is assumed that “1” denotes the last split frame and “0” denotes a 256-th one. In a column RFRSI, a total number of a series of frames transmitted as split frames is stored. In a column RTIST, time stamped at the sensor node when it acquired the present data by sensors is stored. In a column RTEMP, temperature data acquired by the sensor node is stored. In a column RLUX, illuminance data acquired by the sensor node is stored. In a column RBALE, a value indicating the remaining amount of a battery of the sensor node, for example, a power supply voltage is stored. In a column RLQI, a value indicating quality of radio communication between the sensor node and the base station, for example, LQI (Link Quality Indicator) is stored. Ina column RIRDS, the number of detections of infrared data which is stored in the present data is stored. In a column RIR, infrared data acquired by the sensor node is stored. As infrared data, other worker's identification ID and position locating device identification ID are stored. In a column RHD, data acquired by a human motion sensor of the sensor node is stored. In a column RCOL, information acquired by a color sensor of the sensor node is stored. In a column RHUM, information acquired by a humidity sensor of the sensor node is stored.

A table TACC1 stores data on an acceleration sensor instead of data such as infrared in the table TIR. For a sequence of columns from RMACID to RTIST, the same contents as in the table TIR1 are stored. In a column RACDS, the number of detections of acceleration data which is stored in the present data is stored. In a column RACC, acceleration data acquired by the sensor node is stored.

A table TVO1 stores sound data instead of data such as infrared in the table TIR. For a sequence of columns from RMACID to RTIST, the same contents as in the table TIR1 are stored. In a column RVODS, the number of detections of sound data which is stored in the present data is stored. In a column RVODA, sound data acquired by the sensor node is stored.

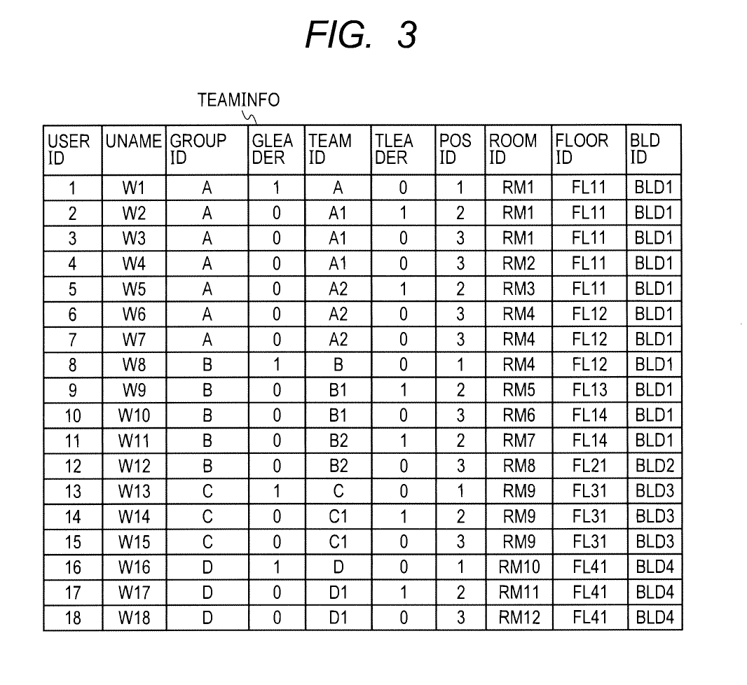

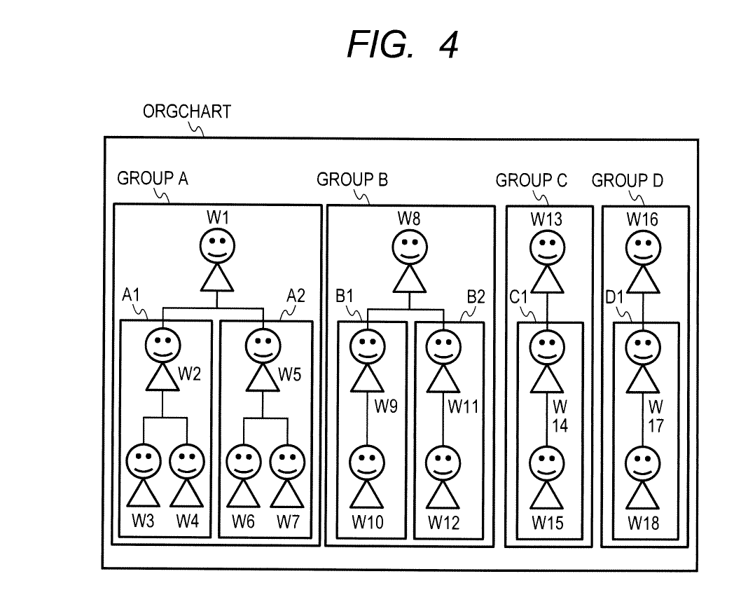

FIG. 3 shows a personal information table TEAMINFO that is stored in the recording device DB1 in FIG. 1. The personal information table TEAMINFO stores worker information such as a group/team to which each worker belongs, duty position, and a place where a worker works, associated with each worker's identification ID. This worker information is to be input beforehand by a data viewer or the like from the display device DISP1 and stored. An example of data of FIG. 3 represents stored data on an organization that is configured as in an organization chart ORGCHART of FIG. 4. According to FIG. 4, there are 18 workers W1 to W18 in the present organization and the organization is comprised of four groups A to D. Leaders of the respective groups are W1, W8, W13, and W16. A group is comprised of one or two teams or more. In the example of FIG. 4, it is assumed that a group A is comprised of two teams and B is comprised of two teams. Team leaders are W2, W5, W9, W11, W14, and W17.

In the personal information table shown in FIG. 3, for example, the following data is stored. In a column USERID, identification ID of a worker that utilizes a sensor node is stored. In a column UNAME, the name of a worker is stored. In a column GROUP ID, ID identifying a group to which a worker belongs is stored. In a column GLEADER, a flag indicative of the leader of a group is stored. For example, 1 for the leader of a group and 0 for other ones are stored. In a column TEAMID, ID identifying a team to which a worker belongs is stored. In a column TLEADER, a flag indicative of the leader of a team is stored. For example, 1 for the leader and 0 for other ones are stored. In a column POSID, information indicative of a duty position is stored. For example, 1 for a manager, 2 for a chief, and 3 for a newcomer are stored. In a column ROOMID, identification information of a room formally registered as a place where each employee works. In a column FLOORID, information identifying a floor where there is the room specified in the column ROOMID is stored. In a column BLDID, information identifying a building or area where there is the floor specified in the column FLOORID is stored.

FIG. 5 shows a structure example of a behavior analysis data table AEDATA that is stored in the recording device DB1 of the management server SV1. The management server SV1 executes the behavior analysis program AR1 on sensed data at prescribed timing, interprets the behavior of each worker, and stores the result into the behavior analysis data table AEDATA.

The structure of the behavior analysis data table AEDATA shown in FIG. 5 is described. In a column RUSID, ID identifying a worker is stored. This ID is obtained by referring to the value of RUSID in each table shown in FIG. 2. In a column RSMIN, time when the sensor node measured data that is stored in the corresponding row is stored. Here, each row is to store data for one minute.

In a column ATEMP, temperature information for the specified time is recorded. This is obtained by referring to the value of temperature data RTEMP in the table TIR1 in the sensor database SD1 and calculating an average or mode value of temperature for the one minute specified. In a column ALUX, illuminance information for the specified time is recorded. Similarly to temperature, this is obtained by referring to the value of illuminance data RLUX in the table TIR1 in the sensor database SD1 and calculating an average or mode value of illuminance for the one minute specified. In a column AHUM, humidity information for the specified time is recorded. Similarly to temperature, this is also obtained by referring to the value of humidity data RHUM in the table TIR1 in the sensor database SD1 and calculating an average or mode value of humidity for the one minute specified.

From the values of the number of detections of acceleration data RACDS and acceleration data RACC in the table TACC1 in which acceleration information was stored, activity of a worker is calculated by a method described below and stored in a column ACTV.

Here, a method for deciding whether or not each worker is in an active state is described. By actively behaving at work, particularly, by collecting information from inside/outside or making heated discussions, it is possible to facilitate developing an idea. Behaviors assumed to be taken in such a case include, inter alia, “face-to-face interactions that are not only verbal, but include motions (gestures)” and “going to a place where a person is present and face to face interacting with the person”. The present inventors conducted an experiment about relation between such behaviors of users and action rhythm. Results such as observation by video showed that a frequency of acceleration is higher for time frames when a person is doing an active work than for other time frames. For example, when a person converses with another person, a 2-3 Hz higher frequency component is observed. Here, thus, a time frame when the frequency of acceleration is higher than a threshold value is regarded as an active state. Typically, it is when the frequency of acceleration is 2 Hz or more. Of course, this value varies from one person to another and depending on a work type and, therefore, the value setting can be changed according to situations.

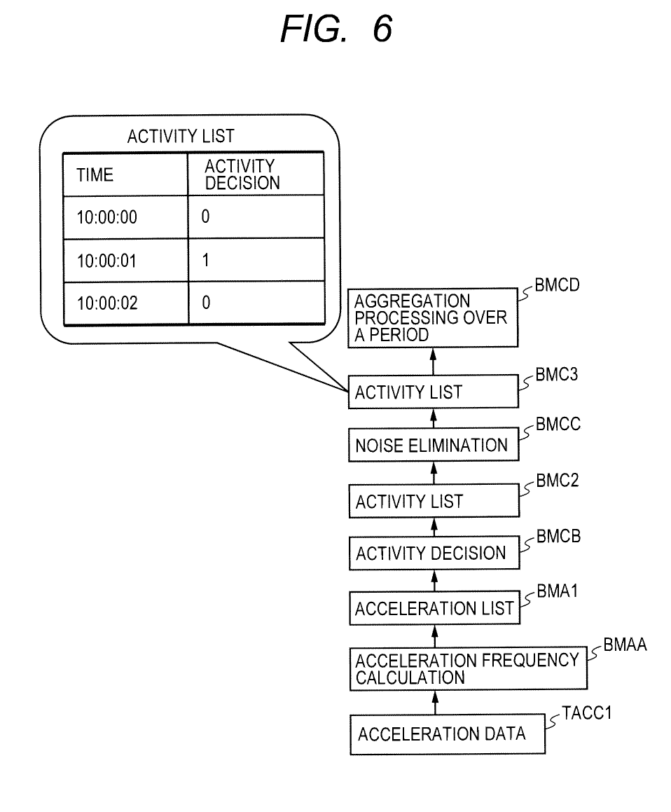

A flow of calculating activity is described using FIG. 6. Acceleration frequency calculation (BMAA) with which it begins is a process of obtaining a frequency from acceleration data (TACC1) arranged in time series. Frequency is defined as the number of wave oscillations per second; that is, it is an indicator representing intensity of oscillation. Although a frequency may be calculated by Fourier transform, a zero crossing value equivalent to a frequency is used in the present embodiment in order to simplify calculation. Thereby, the processing load of the server is reduced, which would be effective in a situation when the amount of calculation of the server increases due to an increasing number of sensor nodes.

The zero crossing value is the counted number of times that a value of time-series data has become zero, more exactly, the counted number of times that time-series data has changed from a positive value to a negative value or from a negative value to a positive value for a given period. For example, given that a period after a value of acceleration changed from positive to negative until it changes from positive to negative again is regarded as one cycle, the number of oscillations per second can be calculated from the counted number of times of zero crossing. The number of oscillations per second thus calculated can be used as an approximate frequency of acceleration.

Moreover, because a sensor node SN0 in the present embodiment is equipped with a triaxial acceleration sensor, a single zero crossing value is calculated by summing up triaxial zero crossing values for a same period. Thereby, particularly, small pendulum motions in crosswise and front-back directions can be detected and a zero crossing value can be used as an indicator representing intensity of oscillation.

As a “given period” for zero-cross counting, a value larger than a serial data interval (i.e., a sensing interval, initially) is set. For example, a zero crossing value per second or per minute will be obtained.

As a result of acceleration frequency calculation (BMAA), zero crossing values per unit time and the number of oscillations in units of seconds calculated therefrom are generated and listed in an acceleration list (BMA1) on memory or as a file.

Then, an activity decision (BMCB) is made on this list (BMA1). As described above, deciding an active/inactive state depends on whether or not acceleration is more than a threshold value. While the list (MBA1) is scanned in order, a decision value “1” indicating an active state is inserted in a row for which the number of oscillations is more than a threshold value and “0” indicating an inactive state is inserted in a row for which the number of oscillations is less than the threshold value. In consequence, an activity list (BMC2) indicating an active/inactive state for each time frame obtained in units of seconds is generated.

Now, there may be a possibility below: even if the number of oscillations is below the threshold at a certain moment, whereas it is above the threshold, thus indicating an active state for a time before and after the moment; inversely, the number of oscillations is above the threshold at a certain moment, whereas it is below the threshold for a time before and after the moment, which actually indicates an active state. A mechanism for eliminating such a momentary noise is needed.

Accordingly, noise elimination (BMCC) is then performed on this list (MBC2). The role of noise elimination is follows: with respect to a time series change of activity obtained as above, for example, a sequence of “0001000111111001111”, it eliminates a momentary change taking account of an anteroposterior relation and generates, for example, a sequence of “0000000111111111111”. By such noise elimination processing, it is possible to calculate activity, taking account of anteroposterior time frames, and to grasp activity reflecting more practical situations. Although noise elimination processing can be carried out by eliminating high frequency components using a low-pass filter, a method based on majority decision is described here as a simpler method. Assume that decision is now made on time frame i. Here, with regard to time frames from time frame i−n to time frame i+n, a total of 2n+1 time frames, active state ones and inactive state ones are counted. If the number of active state ones is larger and time frame i is an inactive state, time frame i is changed to an active state. Inversely, if the number of inactive state ones is larger, time frame i is changed to an inactive state. For example, when this method is applied to a sequence of “0001000111111001111” with n=2, a sequence of “0000000111111111111” is generated. If n is smaller, noise reflecting only a short anteroposterior time is eliminated; if n is larger, noise reflecting a longer time is eliminated. Although what number should be used as n depends on person and work category, a manner of eliminating a minor noise first using a smaller n and, after that, eliminating a somewhat longer noise again using a larger n is also possible. By executing such a method based on majority decision, it is possible to decrease the amount of calculation of the server and reduce its processing load. In consequence, an activity list (BMC3) indicating an active/inactive state for each time frame obtained in units of seconds is generated.

Although this activity list (BMC3) contains data in units of seconds, aggregation processing over a period BMCD can be performed to calculate activity for a longer time unit for the purpose of simplifying subsequence processing. Here, an example of calculating activity in units of minutes from activity in units of seconds is presented. One method is to aggregate seconds judged as an active state for one minute and, if the sum of the seconds is above a threshold value, regard the one minute as an active state. For example, the sum of the seconds exceeds 50%, the one minute is regarded as an active state. Activity of a worker thus calculated is stored in the column ACTV. If the worker is regarded as active, that is, behaving actively, “1” is stored; if regarded as behaving inactively, “0” is stored.

Next, in a column COMM, information indicating whether the worker was engaged in face-to-face interaction with another person for the specified time is stored. For example, “1” is stored when the worker was engaged in face-to-face interaction and “0” is stored when the worker was not engaged in face-to-face interaction. This information is obtained by referring to the column RIR of the table TIR1 in the sensor database SD1 and checking whether or not other worker's identification ID was detected. By aggregating seconds judged as a face-to-face interaction state for the one minute specified, if the sum of the seconds is above a threshold value, the one minute is regarded as a face-to-face interaction state. For example, if the sum of the seconds exceeds 50%, the one minute is regarded as a face-to-face interaction state.

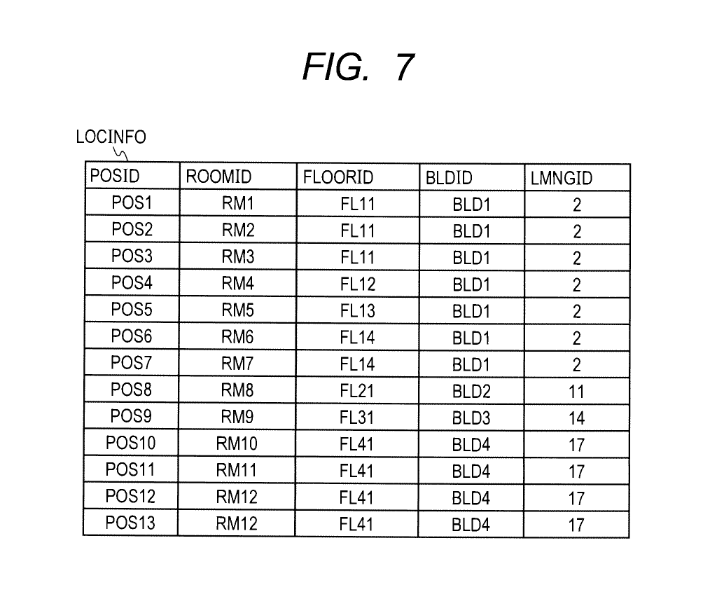

In the last column LOC, the place where the worker is present for the specified time is stored. For this information, reference is made to the column RIR of the table TIR1 in the sensor database SD1 and a position locating device list which is shown in FIG. 7. If the identification ID stored in the column RIR matches with a position locating device identification ID, the position locating device identification ID is stored.

An example presented in FIG. 5 indicates that a worker identified by ID1 was present in a place corresponding to POS1 for one minute from 0:00, when temperature was 26.3° C., illuminance 400.1 Lux, and humidity 40.2%, and the worker was active and not engaged in face-to-face interaction.

The position locating device list of FIG. 7 associatively stores a position locating device identifier, information for a place where the position location device is installed, and worker identification ID denoting a responsible person of each place. These pieces of information are to be input beforehand by a data viewer or the like from the display device DISP1 and stored.

In a column POSID, the identification ID of a position locating device is stored. In a column ROOMID, the identification ID of a room where the corresponding position locating device was installed is stored. In a column FLOORID, the identification ID of a floor where the corresponding position locating device was installed is stored. In a column BLDID, the identification ID of a building where the corresponding position locating device was installed is stored. In a column LMNGID, the identifier of a worker denoting a responsible person of each place is stored.

By executing the state aggregation program SSUM, the management server SV1 aggregates environment information such as temperature when each worker was working separately according to behavior types, based on behavior analysis data. The management server SV1 stores behavior analysis aggregation data resulting from the aggregation into a behavior analysis aggregation data table SAEDATA which is shown in FIG. 8. In FIG. 8, as behavior types, two information items are used: one is whether or not a worker is active, which is stored in the column ACTV in the behavior analysis data table AEDATA; and the other is whether or not a worker is engaged in face-to-face interaction, which is stored in the column COMM in the same table. By combinations of these two information items, classification is made into four states of behavior: active and engaged in face-to-face interaction; active and not engaged in face-to-face interaction; inactive and engaged in face-to-face interaction; and inactive and not engaged in face-to-face interaction.

Concretely, from within the behavior analysis data table AEDATA, with regard to data with a same worker identifier RUSID, an average value of temperature and the like is obtained for each of the above four states. In consequence, average values of environment information in the four states are obtained with respect to each worker, as in FIG. 8. Here, as environment information, average temperature, average illuminance, and average humidity are stored. Also, quantities of occurrence of each state during an aggregation period are totalized and stored in a column TOTAL. Here, time for which each state occurred is stored in units of minutes. Besides, the beginning day of an aggregation period is stored in a column START and the last day is stored in a column END. For a same worker, average values over different periods can be obtained and stored. For example, an average value of temperature over a month can also be stored.

In FIG. 8, it is indicated that, for example, a worker identified by ID1 is in a state inactive and not engaged in face-to-face interaction for 180 minutes during a period of Jan. 1-7, 2010, with an average temperature of 26.3° C., an average illuminance of 400.1 Lux, and an average humidity of 40.2% over the period.

Moreover, by executing the group-wise aggregation program STSUM, the management server 1 aggregates environment information such as temperature during working for each group or team separately according to behavior types, based on behavior analysis data. The management server 1 stores group-wise behavior analysis aggregation data resulting from the aggregation into a group-wise behavior analysis aggregation data table TSUM which is shown in FIG. 9. Aggregating environment information such as temperature is performed in the same manner as aggregation in the behavior analysis data table SAEDATA. Whereas aggregation is performed per worker in the behavior analysis data table of FIG. 8, aggregation is performed jointly on persons belonging to a same group or team in the group-wise behavior analysis aggregation data table TSUM shown in FIG. 9.

For each record of data in the behavior analysis data table AEDATA of FIG. 5, first, by searching for the same ID as the worker identifier RUSID from the column USERID of the personal information table TEAMINFO of FIG. 3, the identifier of a group GROUPID to which the worker belongs is obtained. Then, with regard to data records for workers belonging to a same GROUPID in the behavior analysis data table AEDATA, temperature, illuminance, and humidity data are aggregated. Here, as an example of aggregation, an average and a standard deviation as a variation in environment information across workers are obtained. An average ATEMP and of a standard deviation DTEMP of temperature, an average ALUX and a standard deviation DLUX of illuminance, and an average ARUM and a standard deviation DHUM of humidity are stored.

As is the case for FIG. 8, different aggregations with respect to each of the behavior types are calculated, referring to information in the column ACTV and the column COMM of the behavior analysis data table AEDATA of FIG. 5. In FIG. 9, a row in which ALL is inserted is found in columns ACTV and COMM and this is a row in which data aggregated totally across all the states is stored. Although an aggregation period is omitted, the beginning day (e.g., Jan. 1, 2010) and the last day (e.g., Jan. 7, 2010) of an aggregation period may be stored, as is the case for FIG. 8.

By executing the place-wise aggregation program SLSUM, the management server 1 aggregates environment information such as temperature during working for each place separately according to behavior types, based on behavior analysis data. The management server 1 stores place-wise aggregation data resulting from the aggregation into a place-wise aggregation data table LSUM which is shown in FIG. 10. As is the case for FIG. 9, data records for a plurality of persons are aggregated. Whereas aggregation is performed for each group or team in the group-wise behavior analysis aggregation table of FIG. 9, aggregation is performed on a per-place basis in the place-wise aggregation data table LSUM shown in FIG. 10.

For each data record in the behavior analysis data table AEDATA of FIG. 5, first, by searching for the same ID as the location information LOC from the column POSID of the position locating device list LOCINFO of FIG. 7, the identifier of the corresponding building BLDID is obtained. Then, the identifiers POSIDs of position locating devices associated with the same BUILD ID are picked out. With regard to data records having the POSIDs in the behavior analysis data table AEDATA, temperature, illuminance, and humidity data are aggregated. Here, as an example of aggregation, an average and a standard deviation as a variation in environment information across workers are obtained. An average ATEMP and of a standard deviation DTEMP of temperature, an average ALUX and a standard deviation DLUX of illuminance, and an average AHUM and a standard deviation DHUM of humidity with respect to each place are stored. As is the case for FIG. 9, different aggregations with respect to each of the behavior types are calculated, referring to information in the column ACTV and the column COMM of the behavior analysis data table AEDATA of FIG. 5.

Although an example of aggregations per building is shown in FIG. 10, aggregations per floor FLR can also be performed in the same method. Although an aggregation period is omitted, the beginning day (e.g., Jan. 1, 2010) and the last day (e.g., Jan. 7, 2010) of an aggregation period may be stored, as is the case for FIG. 8.

By executing the behavior analysis program SPSUM, the management server SV1 calculates work efficiency data indicating the work efficiency of each worker and stores this data into a work efficiency data table PSUM which is shown in FIG. 11. Here, information representing the work efficiency of each worker is calculated from behavior information on each worker.

In FIG. 8, four states are defined by combinations of ACTV and COMM. Among them, a state not engaged in face-to-face interaction and inactive can be considered as a state in which a person concentrates on working alone. On the other hand, a state not engaged in face-to-face interaction and active can be considered as a state in which a person does not perform a concentrative work, for example, he or she may move or do filing or the like. For a work of doing document preparation or development with concentration, it becomes a goal to increase the former concentration time and decrease the latter non-concentration time. Thus, a concentration time rate is calculated, referring to the amount of occurrence TOTAL of each state in the behavior analysis aggregation data table SAEDATA shown in FIG. 8, and stored in a column CONRATIO in FIG. 11. The concentration time rate is calculated by (a total time of a state not engaged in face-to-face interaction and inactive)/(a total time of a state not engaged in face-to-face interaction). In a column TOTALSOLO, a total time of a state not engaged in face-to-face interaction and inactive and a state not engaged in face-to-face interaction and active is stored. In a column NUMCON, a time of a state not engaged in face-to-face interaction and inactive is stored. FIG. 11 presents an example in which a worker W1 is in an inactive state for 180 minutes during 240 minutes of a state not engaged in face-to-face interaction and a concentration time rate is 0.75.

A similar relation also exists between a state engaged in face-to-face interaction and inactive and a state engaged in face-to-face interaction and active. The state engaged in face-to-face interaction and active can be considered as a state in which a person talks to the other person or nodes or reacts to a talk of the other person. Conversely, the state engaged in face-to-face interaction and inactive can be considered as a state in which a person only listens to a talk of the other person or does not listen, having no particular interest in the subject. In face-to-face interaction, it becomes a goal to increase the former active time and decrease the inactive state. Thus, an activeness rate of face-to-face interaction is calculated, referring to the amount of occurrence TOTAL of each state in the behavior analysis aggregation data table SAEDATA shown in FIG. 8, and stored in a column ACTVRATIO in FIG. 11. The activeness rate of face-to-face interaction is calculated by (a total time of a state engaged in face-to-face interaction and active)/(a total time of a state engaged in face-to-face interaction). In a column TOTALCOMM, a total time of a state engaged in face-to-face interaction and active and a state engaged in face-to-face interaction and inactive is stored. In a column NUMACTV, a time of a state engaged in face-to-face interaction and active is stored. FIG. 11 presents an example in which a worker W1 is in an active state for 45 minutes during 110 minutes of a state engaged in face-to-face interaction and an activeness rate of face-to-face interaction is 0.41.

Besides, by executing the proper environment analysis program SEAN, the management server SV1 calculates proper environment information PVALUE based on the work efficiency data and environment information. A case of calculating a proper temperature based on concentration time rates and temperature data is described. First, reference is made to the concentration time rate of each worker stored in the work efficiency data table PSUM shown in FIG. 11 and temperature data on each worker stored in the behavior analysis aggregation data table SAEDATA shown in FIG. 8. Then, temperatures within a predetermined range (e.g., the temperatures on workers whose concentration time rates account for upper 25%) are calculated as a proper temperature PVALUE. The temperature on a worker having the highest concentration time rate may be taken as a proper temperature.

The management server SV1 periodically executes each of the above programs and associatively outputs calculated pieces of information to the display device DISP1. The display device DISP1 processes the received pieces of information and displays them in graph form or the like. Alternatively, when a request is issued by a user via the display device DISP1, a certain program is executed according to the request, and calculated pieces of information are output to the display device DISP1, thereby being displayed on the display device DISP1.

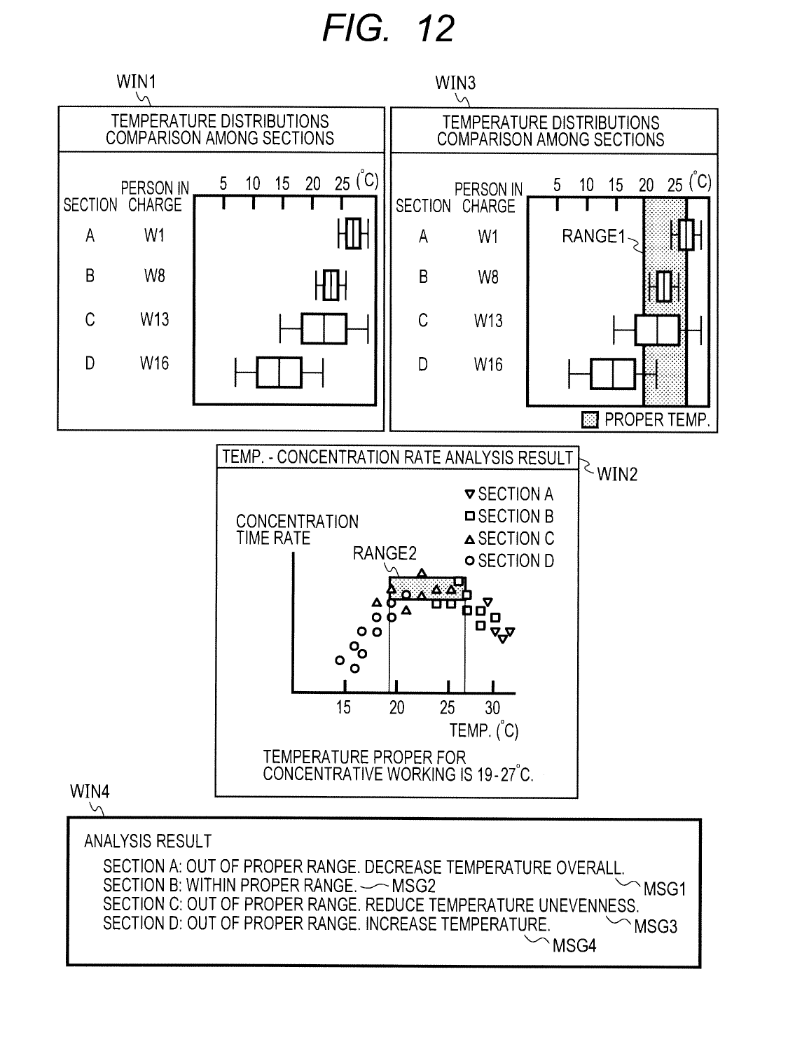

FIG. 12 shows an example of data that is displayed on the display device DISP1. WIN1 to WIN4 in FIG. 11 represent windows that are displayed on the screen of DISP1.

In a window WIN1, workers' temperature distributions per group are displayed with temperatures information plotted on the abscissa and groups on the ordinate. Based on the personal information table shown in FIG. 3 and the behavior analysis aggregation data table shown in FIG. 8, the management server SV1 associates workers' temperatures with each group and the display device DISP1 displays them in form of a box-and-whisker plot. Here, it is shown that the temperatures of 50% workers in each group fall within a box associated with each group and the center line of the box indicates a median of temperatures of each group. It can be seen from this figure that section A is of the highest temperature and section D is of the lowest. It can also be seen that section B and section C have similar median temperatures, but there is a larger variation in temperature of section C. It is also possible to display the values of average temperature and standard deviation of temperature per group, based on the group-wise behavior analysis aggregation data shown in FIG. 9.

In this way, a display is provided of temperature distributions associated with person groups constituting an organization. Here, the person groups are departments, sections, teams, groups, etc. which generally exist in an organization. By this display, it can easily be understood that environmental conditions of which person group are problematic and wasteful. A spot where the environmental conditions should be remedied is made clear and efficient energy management can be performed.

Moreover, the management server SV1 can associate temperature distributions per section with responsible persons based on the personal information table and additionally display the responsible persons of the sections as the persons in charge. Thereby, who is responsible for the section can easily be understood and more efficient energy management can be performed. In FIG. 12, for example, it can be appreciated that what is to be done is contacting a worker W1 who is in charge of the section A and advising the worker to decrease temperature.

Here, a proper temperature for a group is considered. For example, a proper temperature for a person doing a concentrative work differs from a proper temperature for persons who talk with each other in a break, meeting, etc. When comparing persons who more often do a concentrative work and persons who more often do an active work, suppose if the persons who more often do a concentrative work were working under a high temperature setting? At this time, a conclusion made to decrease energy consumption by decreasing the temperature setting for persons who concentrate on working, taking account of only a viewpoint of energy saving, is not always good for the group. That is, it is important for a group to conduct energy management from the viewpoints of energy saving and productivity of the group. Besides, what work in which a worker engages may change over time. In addition, persons doing different works may coexist in one space. Taking account of such work change and work diversity, it is necessary to determine and control a proper temperature. In the present embodiment, it is possible to show a proper temperature per behavior by making use of work efficiency data.

A window WIN2 displays a distribution of temperatures information and concentration time rates in a scatter diagram with temperatures information on each worker plotted on the abscissa and concentration time rates of each worker on the ordinate. The display device DISP1 acquires temperatures information on each worker from the behavior analysis aggregation data table SAEDATA. Also, it acquires concentration time rates of each worker from the work efficiency data table PSUM. One mark in the window WIN2 corresponds to one worker. By thus displaying a distribution of temperatures information and concentration time rates in a scatter diagram, the viewer can take a broad view of a relation between temperatures which are one of environment information and concentration time rates which are one of indicators of the productivity of each group.

The display device DISP1 can also display a proper temperature calculated by the management sever SV1 based on concentration time rates. In FIG. 12, a range of temperatures on persons whose concentration time rates account for upper 25% among the workers is regarded as a proper temperature. In FIG. 12, the proper temperature is about 19-27° C. and is displayed in a rectangular form like RANGE2. By thus displaying a proper temperature, it can be appreciated that what level of temperature should be maintained to increase a concentration time rate.

A display of a proper temperature associated with actual temperature distributions per group, which is superimposed on the window WIN1, is provided in a window WIN3. A proper temperature calculated based on concentration time rates is displayed in a rectangular form like RANGE1 superimposed on actual temperature distributions. Thereby, it is possible to grasp a proper temperature, taking account of what work in which a worker engages. And the viewer can intuitively know that environmental conditions should be remedied preferentially for groups A and D that are out of the proper range. If energy saving is only taken into consideration, there is a possibility of decreasing temperature excessively. By displaying a proper temperature, it is possible to take both energy management and maintaining productivity into consideration.

In a window WIN4, an analysis result obtained by using information in the above windows WIN1 to WIN3 is displayed. Based on the proper temperature, it is possible to generate information that should be conveyed to a person group or its manager, such as information (MSGs 1-4) that should be pointed out to a group (section) out of the proper range or its person in charge and pointed out to a group (section) having a large temperature variation. Such information (MSGs 1-4) can be generated by either the server SV1 or the display device DSIP1.

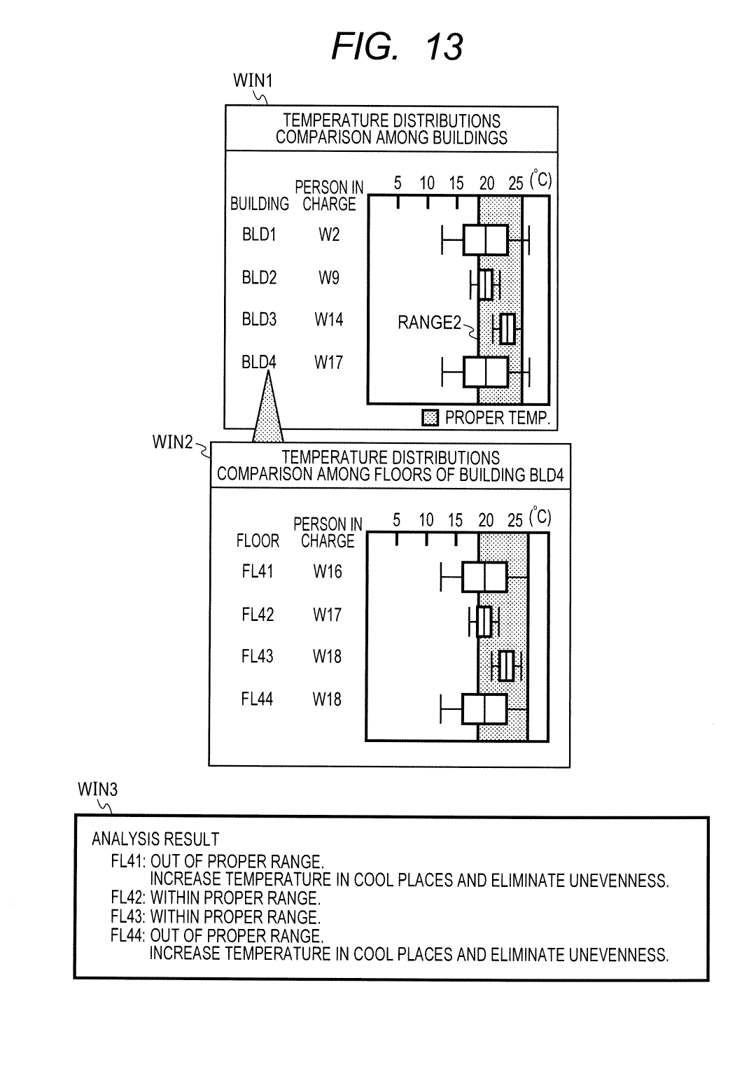

Although an environment information aggregation result per group is displayed in FIG. 12, an environment information aggregation result per place can also be displayed. The display device DISP1 refers to the position locating device list shown in FIG. 7 and the place-wise aggregation data table LSUM shown in FIG. 10 and displays an environment information aggregation result per group. An example hereof is shown in FIG. 13. In a window WIN1, a display is provided of aggregation information on a per-building basis. A manner of displaying a proper temperature is the same as described for FIG. 12. Also, further analysis is enabled by specifying one building. As an example, a display that is provided when BLD4 has been selected in the window W1 via the input device of the display device DISP1 is shown in a window WIN2. In this window, an aggregation result per floor of the building BLD4 is displayed. From information thus displayed, it can be seen that BLD1, BLD4, FL41, and FL44 are out of the proper range. Additionally, in a window WIN3, information such as pointing out a floor out of the proper range and a floor having a large temperature variation is displayed.

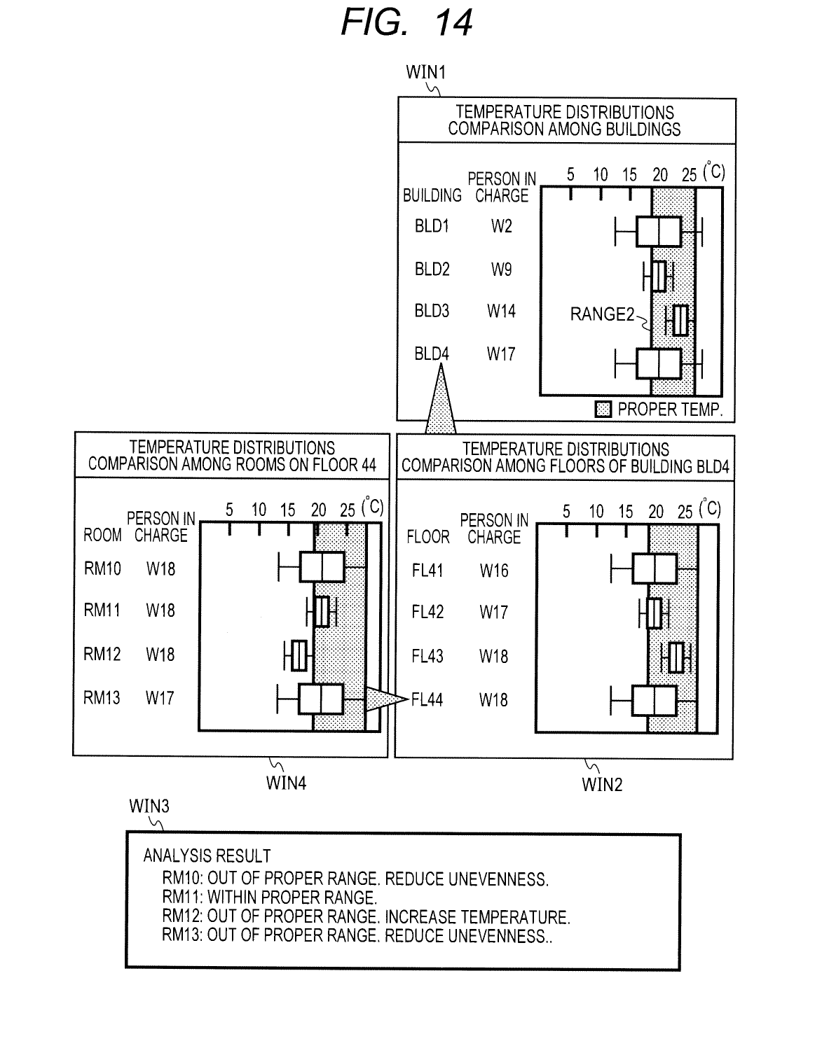

An example of a display of aggregation information in terms of place subdivisions is shown in FIG. 14. Here, a new window WIN4 is displayed. This window is displayed when a floor FL44 has been selected in the window WIN2 in FIG. 13 and provides a display of an environment information aggregation result for each of rooms ROM10 to ROM13 on the floor 44. Additionally, in a window WIN3, information such as pointing out a room out of the proper range and a room having a large temperature variation is displayed.

In FIGS. 12 through 14, there is displayed a proper temperature calculated by the management server SV1 with a perspective of increasing the concentration time rates of workers of a group. However, some groups may place more importance on works without regarding concentration time. Then, the following describes an example of displaying a proper temperature calculated by the management server SV1 with a perspective of increasing the activeness rate of face-to-face interaction of a group.

The management server SV1 refers to the activeness rate of face-to-face interaction of each worker stored in the work efficiency data table PSUM shown in FIG. 11 and temperature data on each worker stored in the behavior analysis aggregation data table SAEDATA shown in FIG. 8. It then calculates temperatures within a predetermined range (e.g., the temperatures on workers whose activeness rates of face-to-face interaction account for upper 25%) as a proper temperature PVALUE. The temperature on a worker having the highest activeness rate of face-to-face interaction may be taken as a proper temperature.

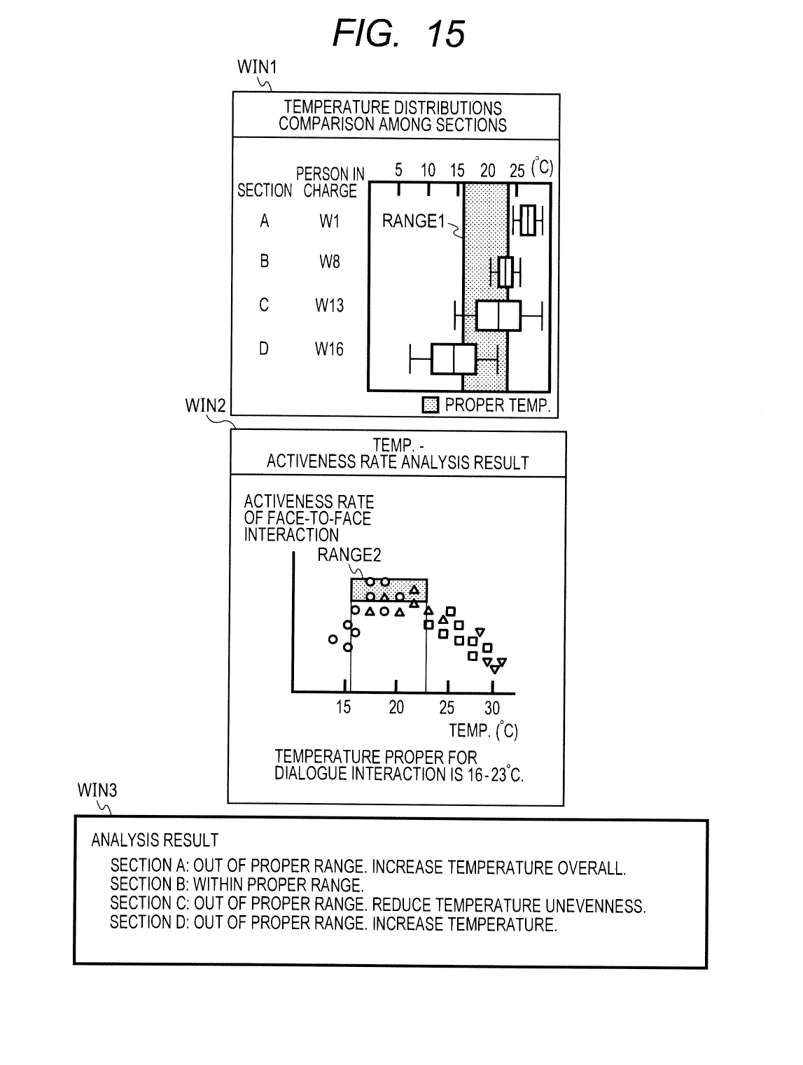

In the same manner as described for FIG. 12, the display device DISP1 displays the temperatures of workers per group in form of a box-and-whisker plot. A proper temperature calculated by the management server SV1 based on activeness rates of face-to-face interaction is also superimposed and displayed. A display example hereof is shown in a window WIN1 in FIG. 15.

In a window WIN2 in FIG. 15, there is displayed a distribution of temperatures information and activeness rates of face-to-face interaction in a scatter diagram with temperatures information on each worker plotted on the abscissa and activeness rates of face-to-face interaction on the ordinate. In this case, there may be a different distribution from the distribution with regard to concentration time rates. In the case of FIG. 15, an example is displayed in which the activeness rate of face-to-face interaction becomes maximal at about 18° C. A proper temperature ranges from 16° C. to 23° C. (RANGE2); persons of 25% who have a high activeness rate of face-to-face interaction fall within this range. As is the case for FIG. 12, a proper temperature display RANGE1 in WIN1 and an analysis result in window WIN3 are also displayed together with this proper temperature. By thus displaying a proper temperature based on activeness rates of face-to-face interaction, superimposed on actual temperature distributions, it is possible to conduct energy management, while taking account of maintaining productivity.

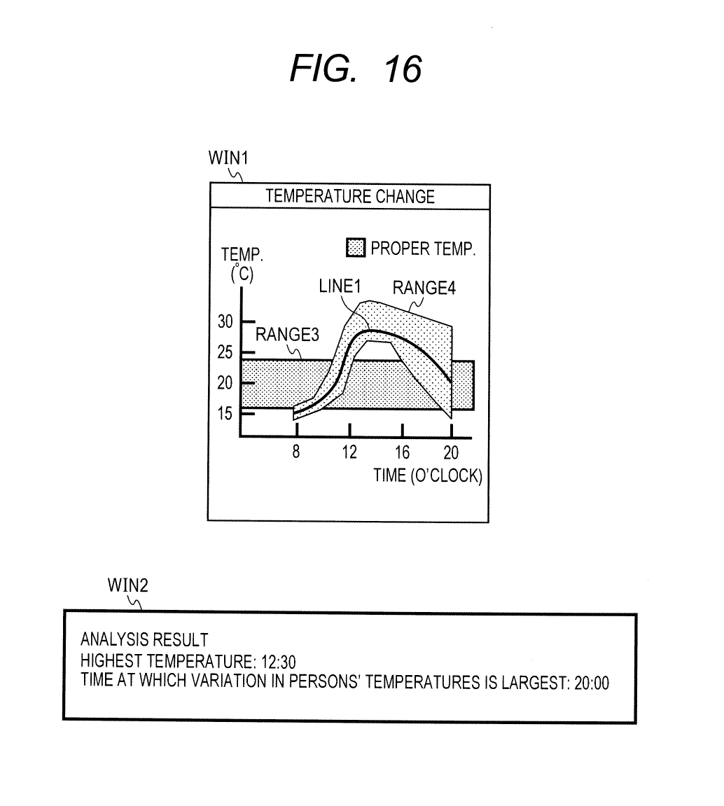

In FIG. 16, temperature change over time in a day is displayed as in WIN1. In this figure, time is plotted on the abscissa and the ordinate indicates an average temperature at each time. A proper temperature range obtained in the window WIN2 shown in FIG. 15 is displayed like RANGE3. The management server SV1 calculates an average temperature at each time for all workers from the behavior analysis data shown in FIG. 5 and the display device DISP1 shows the result in a bold line like LINE1. Further, in order to show a variation among all workers' temperatures, the management server SV1 obtains a standard deviation of temperature at each time for all workers from the behavior analysis data shown in FIG. 5. The display device DISP1 displays the result by an object with a breadth as marked RANGE4. By displaying these, the viewer will be allowed to intuitively know things such as which point of time when the workers' temperatures become out of the proper temperature range, they are generally out of the proper range, and they vary largely. Moreover, an analysis result based on the window WIN1 is displayed as is shown in a window WIN2 in FIG. 16. In an example in FIG. 16, the highest temperature and the time at which variation in the persons' temperatures is largest are shown.

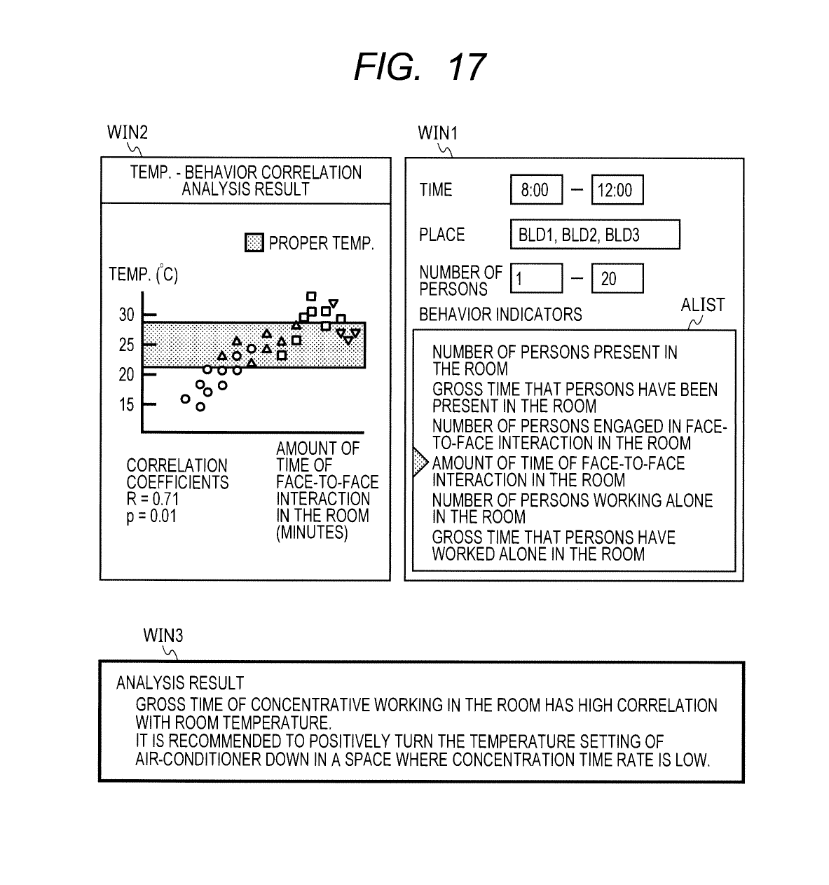

A room temperature may depend on an outside air temperature and a temperature setting of an air conditioner. Actually, however, temperature may vary depending on behavior, even if measured in the same office, during the same time zone, and with the same number of persons. In FIG. 17, a display is shown to analyze a relation between temperature and a set of various behaviors.

With an interface like a window WIN1 in FIG. 17, a user specifies a time range for analysis to run and a target place via the input device of the display device DISP1. If the user wants analysis to run only when a particular number of persons are present in the room, the user specifies the number of persons. The user also selects a behavior indicator (for example, the number of persons engaged in face-to-face interaction in the room, an amount of time of face-to-face interaction in the room, etc.) that the user wants to check its relation with temperature from a list ALIST. The management server SV1, upon receiving selected information, calculates the behavior indicator per worker by executing the behavior and environment information correlation analysis program SPAN. For example, if the server calculates a behavior indicator, an amount of time of face-to-face interaction, the server refers to the behavior analysis data table and the position locating device list, extracts behavior analysis data acquired in the place specified by the user during the time range specified by the user, and only has to aggregate time during which each worker face to face interacts with another worker from within the extracted behavior analysis data. The display device DISP1, upon receiving the calculation result, displays a scatter diagram with the behavior indicator plotted on the abscissa in the window WIN2. The management server SV1 also performs a correlation analysis between the selected behavior indicator and temperature and the display device DISP1 displays the result of this analysis as well. High correlation coefficients indicate that the behavior indicator correlates with temperature. Besides, the management server SV1 performs a correlation analysis between a set of various behavior indicators as shown in the list ALIST and temperature and determines which indicator most correlates with temperature. The display device DISP1 displays the analysis result in WIN3. By thus examining a relation between a behavior indicator and temperature, detailed analysis and remedy are possible.

Although the examples of displaying and analyzing temperature information have been described with FIGS. 12 through 17, the same manner of display and analysis is possible with humidity and illuminance other than temperature. By displaying these items in order or all items at a time, it is possible to grasp and analyze more overall conditions.

### Second Embodiment

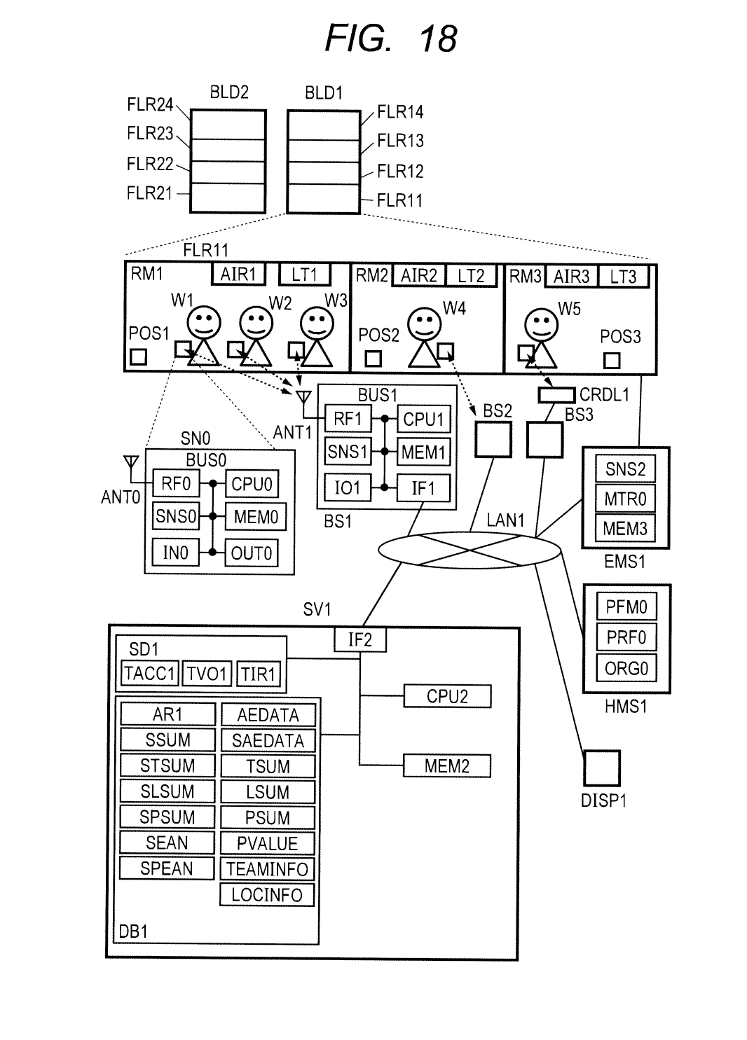

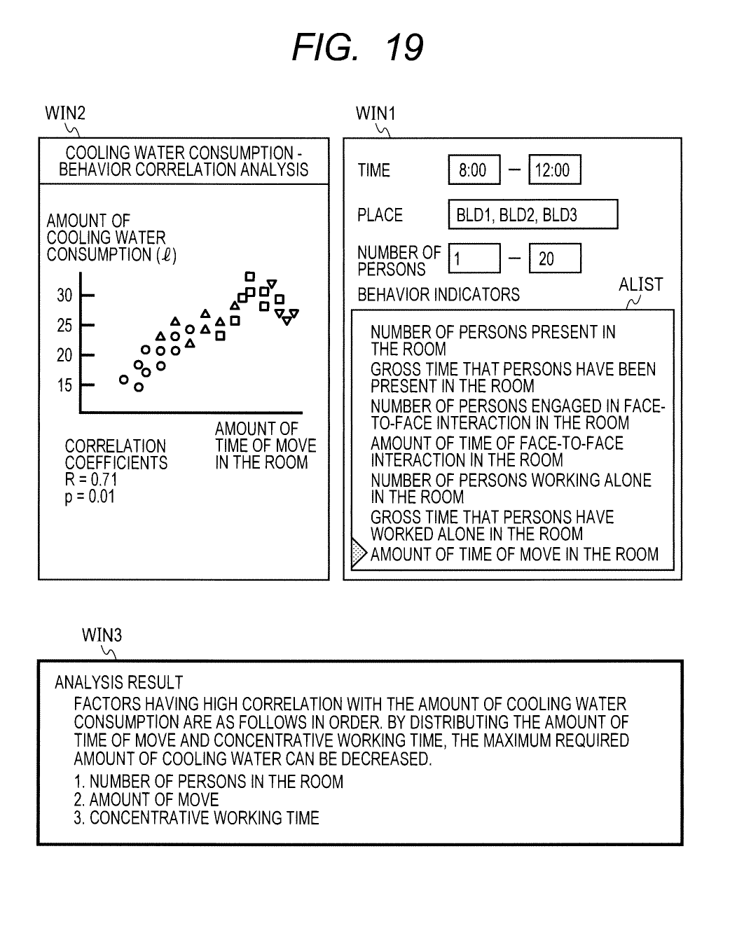

A structure of a second embodiment of the present invention is described using FIG. 18 and FIG. 19.

The second embodiment is characterized in that an energy management system for monitoring energy consumption in each building is provided to enable analyzing a relation between energy usage in a building and a behavior indicator.

FIG. 18 is a diagram showing a system structure according to the present embodiment. The same components as in the first embodiment are assigned the same reference signs and their descriptions are omitted here. In the present embodiment, it is a feature that the management server SV1 is provided with a behavior and energy correlation analysis program SPEAN.

In buildings BLD1 and BLD2, an energy management system EMS1 is provided to monitor energy consumption. This system is comprised of a suite of sensors SNS2 for sensing temperature, humidity, luminance, etc. in each room and building, meters MTR0 for measuring electricity and water consumptions, and a memory MEM3 storing sensor data and measurement data. By using this system, it is possible to analyze a relation between usage of energy such as electricity, water, and gas in a building and behavior.

FIG. 19 shows an example of a display and analysis using the system EMS1 that manages energy usage of buildings and information sensed by stationary sensors in addition to information acquired by sensors that the workers carry. In the management system EMS1, usage of cooling water by air conditioner, experimental equipment, etc. is managed per room using the meters MTR0. In this case, via the management server SV1, it is possible for a user to check out how a behavior in each room relates to the usage of cooling water.

With an interface like a window WIN1 in FIG. 19, a user specifies a time range for analysis to run and a target place via the input device of the display device DISP1. If the user wants analysis to run only when a particular number of persons are present in the room, the user specifies the number of persons. The user also selects a behavior indicator (for example, the number of persons engaged in face-to-face interaction in the room, an amount of time of face-to-face interaction in the room, etc.) that the user wants to check its relation with cooling water consumption from a list ALIST. The management server SV1, upon receiving selected information, calculates the behavior indicator per worker by executing the behavior and energy correlation analysis program SPEAN. For example, if the server calculates a behavior indicator, an amount of time of move in the room, the server refers to the behavior analysis data table and the position locating device list, extracts behavior analysis data acquired in the place specified by the user during the time range specified by the user, and only has to aggregate time during which each worker is active from within the extracted behavior analysis data. The display device DISP1, upon receiving the calculation result, displays a scatter diagram with the behavior indicator plotted on the abscissa in the window WIN2. The management server SV1 also performs a correlation analysis between the selected behavior indicator and cooling water consumption acquired from the energy management system EMS1 and the display device DISP1 displays the result of this analysis as well. High correlation coefficients indicate that the behavior indicator correlates with cooling water consumption.

Besides, the management server SV1 picks out a plurality of indicators that relate to cooling water consumption from a set of behavior indicators by using a statistical method such as principal component analysis and multiple regression analysis. The display device DISP1 can display these indicators in order, as in a window WIN3. By thus examining a relation between cooling water consumption and a behavior indicator, it is possible to analyze in more detail the relation between cooling water consumption and the behavior indicator and take a remedial action. Besides cooling water consumption, it is possible to handle in a similar way electricity usage, gas usage, computer network traffic, etc., that can be managed per room.

Besides, in the LAN1, there may be a management system HMS1 for managing each worker's profile and work information. This system stores work performance PFM0 such us earning and an amount of work handled by each worker, person information PRF0 in which ability, experience and evaluation of each worker are stored, and organization information ORG0 in which organization structure and groups to which workers belong to are stored. Using these pieces of information, it is possible to analyze a relation between usage of energy such as electricity, water, and gas in a building and worker attributes such as work experience and productivity.

While the embodiments of the present invention has been described, it will be appreciated by those skilled in the art that the invention is not limited to the foregoing embodiments, various modifications may be made therein, and the foregoing embodiments may be combined appropriately.

The present invention can be applied to diverse circumstances where a plurality of persons gathered. Monitored persons do not need to belong to a same company and may be those in a building in which a plurality of companies gathered, a shopping mall in which a plurality of department stores gathered, and a community or town in which a plurality of buildings collected. They do not need to exist in a same physical space. For example, comparison can be made between branches being in different areas or countries.

### LIST OF REFERENCE SIGNS

SN0 Sensor node
BS1, BS2, BS3 Base station device
POS1, POS2, POS3 Position locating device
SV1 Management server
LAN1 Wired network
CPU0, CPU1, CPU2 Processor
IF1, IF2 Network interface
SNS0, SNS1 A suite of sensors
RF0, RF1 Radio circuit
MEM0, MEM1, MEM2 Memory
SD1 Sensor database
DB1 Recording device
AR1 Behavior analysis program
SSUM State aggregation program
STSUM Group-wise aggregation program
SLSUM Place-wise aggregation program
SPSUM Behavior analysis program
SEAN Proper environment analysis program
SPAN Behavior and environment information correlation analysis program
SPEAN Behavior and energy correlation analysis program

1. An information processing system comprising a terminal that is attached to each of a plurality of users who constitute an organization, a base station that communicates with the terminal, and a server connected to the base station via a network,
the terminal comprising a first sensor acquiring environment information and a transmitter that transmits the environment information to the base station,
the server comprising a network interface connected to the network, a processor connected to the network interface, and a recording device connected to the processor,
wherein the recording device records a personal information table that stores an association of each of the plurality of users with a person group to which each of the plurality of users belongs in the organization, and
wherein the processor receives the environment information via the network interface and records the environment information into the recording device; based on the environment information, aggregates and records environment information for each the user for a given period into the recording device; and refers to the personal information table, calculates environment information for each the person group for a given period from the environment information for each the user for a given period, and outputs the result to a display device connected to the information processing system.

2. The information processing system according to claim 1,
wherein the environment information is at least any one of temperature information, illuminance information, and humidity information.

3. The information processing system according to claim 1,
wherein the personal information table stores an association of each the person group with a responsible person of the group, and
wherein the processor associates the environment information for each the person group for a given period with a responsible person of the group, based on the personal information table, and outputs the result to the display device.

4. The information processing system according to claim 1,
wherein the terminal further comprises a second sensor acquiring acceleration information and a third sensor acquiring information indicating face-to-face interaction with another user,
wherein the transmitter transmits the acceleration information and the information indicating face-to-face interaction to the base station, and
wherein the processor decides whether or not each the user is in an active state depending on whether or not the acceleration exceeds a predetermined threshold value based on the acceleration information, decides whether or not each the user is in a state engaged in face-to-face interaction with another user based on the information indicating face-to-face interaction, and calculates and records environment information for a given period for each of four states which are combinations of active/inactive states and states engaged/not engaged in face-to-face interaction into the recording device.

5. The information processing system according to claim 4,
wherein, based on the active/inactive states and the states engaged/not engaged in face-to-face interaction, the processor calculates and records work efficiency data indicating work efficiency for each the user into the recording device, calculates proper environment information based on the work efficiency data for each the user and the environment information, and outputs the result to the display device.

6. The information processing system according to claim 5,
wherein, as the work efficiency data, the processor calculates a concentration time rate for each the user from a ratio of an amount of time that the user is in a state inactive and not engaged in face-to-face interaction to an amount of time that the user is in a state not engaged in face-to-face interaction and calculates an activeness rate of face-to-face interaction for each the user from a ratio of an amount of time that the user is in a state active and engaged in face-to-face interaction to an amount of time that the user is in a state engaged in face-to-face interaction.

7. The information processing system according to claim 5,
wherein, among environment information on the plurality of users, the processor determines environment information on users whose work efficiency falls within a predetermined range as the proper environment information.

8. The information processing system according to claim 5,
wherein the processor associates the environment information for each the person group for a given period with the proper environment information and outputs the result to the display device.

9. A server connected via a network to a base station communicating with a terminal that is attached to each of a plurality of users who constitute an organization, the server comprising:
a network interface connected to the network;
a processor connected to the network interface; and
a recording device connected to the processor,
wherein the recording device records a personal information table that stores an association of each of the plurality of users with a person group to which each of the plurality of users belongs in the organization,
wherein the processor receives environment information acquired by the terminal via the network interface and stores the environment information into the recording device; based on the environment information, aggregates and records environment information for each the user for a given period into the recording device; and refers to the personal information table, calculates environment information for each the person group for a given period from the environment information for each the user for a given period, and outputs the result to a display device connected to the network.

10. The server according to claim 9,
wherein the environment information is at least any one of temperature information, illuminance information, and humidity information.

11. The server according to claim 9,
wherein the personal information table stores an association of each the person group with a responsible person of the group, and
wherein the processor associates the environment information for each the person group for a given period with a responsible person of the group, based on the personal information table, and outputs the result to the display device.

12. The server according to claim 9,
wherein the processor receives acceleration information and information indicating face-to-face interaction with another user, which are acquired by the terminal, and
wherein the processor decides whether or not each the user is in an active state depending on whether or not the acceleration exceeds a predetermined threshold value based on the acceleration information, decides whether or not each the user is in a state engaged in face-to-face interaction with another user based on the information indicating face-to-face interaction, and calculates and records environment information for a given period for each of four states which are combinations of active/inactive states and states engaged/not engaged in face-to-face interaction into the recording device.

13. The server according to claim 9,
wherein, based on the active/inactive states and the states engaged/not engaged in face-to-face interaction, the processor calculates and records work efficiency data indicating work efficiency for each the user into the recording device, calculates proper environment information based on the work efficiency data for each the user and the environment information, and outputs the result to the display device.

14. The server according to claim 13,
wherein, as the work efficiency data, the processor calculates a concentration time rate for each the user from a ratio of an amount of time that the user is in a state inactive and not engaged in face-to-face interaction to an amount of time that the user is in a state not engaged in face-to-face interaction and calculates an activeness rate of face-to-face interaction for each the user from a ratio of an amount of time that the user is in a state active and engaged in face-to-face interaction to an amount of time that the user is in a state engaged in face-to-face interaction.

15. The server according to claim 13,
wherein, among environment information on the plurality of users, the processor determines environment information on users whose work efficiency falls within a predetermined range as the proper environment information.

16. The server according to claim 13,
wherein the processor associates the environment information for each the person group for a given period with the proper environment information and outputs the result to the display device.

17. An information processing method using an information processing system comprising a terminal that is attached to each of a plurality of users who constitute an organization, a base station that communicates with the terminal, and a server connected to the base station via a network, the information processing method in which:
the terminal acquires environment information and transmits the environment information to the base station;
the server associates beforehand each of the plurality of users to a person group to which each of the plurality of users belongs in the organization;
based on the environment information, the server aggregates environment information for each the user for a given period;
using an association of each of the plurality of users with each the person group, the server calculates environment information for each the person group for a given period from the environment information for each the user for a given period; and
the environment information for each the person group for a given period is displayed.

18. The information processing method according to claim 17,
wherein the server associates beforehand each the person group with a responsible person of the group, and
using an association of each the person group with a responsible person, the environment information for each the person group for a given period associated with a responsible person of the group is displayed.

19. The information processing method according to claim 17,
wherein the terminal acquires acceleration information and information indicating face-to-face interaction with another user, and
wherein the server decides whether or not each the user is in an active state depending on whether or not the acceleration exceeds a predetermined threshold value based on the acceleration information, decides whether or not each the user is in a state engaged in face-to-face interaction with another user based on the information indicating face-to-face interaction, calculates work efficiency data indicating work efficiency for each the user based on active/inactive states and states engaged/not engaged in face-to-face interaction, calculates proper environment information based on the work efficiency data for each the user and the environment information, and
wherein the environment information for each the person group for a given period associated with the proper environment information is displayed.
